(19) United States
(12) Patent Application Publication
(10) Pub. No.: US 2018/0117787 A1
(43) Pub. Date: May 3, 2018

(54) STAPLER

(71) Applicant: MAX CO., LTD., Tokyo (JP)

(72) Inventors: Toshio SHIMIZU, Tokyo (JP); Futoshi KAMEDA, Tokyo (JP); Shinpei SUGIHARA, Tokyo (JP)

(73) Assignee: MAX CO., LTD., Tokyo (JP)

(21) Appl. No.: 15/786,654

(22) Filed: Oct. 18, 2017

(30) Foreign Application Priority Data
Oct. 31, 2016 (JP) 2016-213886

(51) Int. Cl. B27F 7/19; B25C 5/02; B27F 7/36

(52) U.S. Cl. CPC B27F 7/19; B27F 7/38; B27F 7/36; B25C 5/0207

(57) ABSTRACT

A stapler includes a staple striking portion configured to strike a staple to penetrate sheets of paper and a clincher portion configured to bend staple legs of the staple penetrating the sheets of paper. The clincher portion includes a pair of clinchers. The pair of clinchers are configured to perform a first operation and a second operation. In the first operation, the pair of the clinchers move along a surface direction of the sheets of paper to approach each other. In the second operation, the pair of clinchers move to approach the sheets of paper after the first operation.

### CROSS-REFERENCE TO RELATED APPLICATION

This application claims priority from Japanese Patent Application No. 2016-213886 filed on Oct. 31, 2016, the entire contents of which are incorporated herein by reference.

### TECHNICAL FIELD

The present invention relates to a stapler for binding a plurality of sheets of paper with a staple.

### BACKGROUND

In electric staplers used in post-processing devices, a clincher mechanism is typically equipped for bending staple legs of a staple, which penetrate sheets of paper, along a surface the sheets of paper (e.g., see Japanese Utility Application Publication No, Sho 61-105583). However, in conventional staplers, the staple legs of the staple penetrating the sheets of paper are likely not to be properly bent onto the sheets of paper, so that a poor binding, such as buckling of staple legs, reverse bending, rising-up of staple legs or lifting of staple legs, is occurred.

Thus, in order to inhibit a poor binding, a stapler, in which a pair of clincher mechanism configured to bend staple legs by a pivoting motion thereof are provided, is disclosed from Japanese Patent Application Publication No. Hei 11-207654 and Japanese Patent Application Publication No. 2005-119246.

In the clincher mechanism configured to bend staple legs by a pivoting motion as describe above, it is necessary to position pivot fulcrums of clinchers to locations, which are near to the middle of the stapler in a width direction thereof and also spaced from the sheets of paper, in order to inhibit a poor binding and thus to properly bend the staple legs. However, if the pivot fulcrums of the clinchers are spaced from the sheets of paper, there is a problem that a height of the clincher mechanisms is increased and thus a height of the entire stapler is also increased.

Accordingly, the present invention has been made to solve the above problems, and an object thereof is to provide a stapler in which it is possible to realize a stabilized bent shape of staple legs and also to keep a height of the stapler lower.

### SUMMARY

In order to solve the above object, the present invention is a stapler, including a staple striking portion for striking a staple to penetrate sheets of paper; and a clincher portion for bending staple legs of the staple penetrating the sheets of paper; wherein the clincher portion includes a pair of clinchers; wherein the pair of clinchers are configured to perform a first operation, in which the pair of the clinchers move along a surface direction of the sheets of paper to approach each other, and a second operation, in which the pair of clinchers move to approach the sheets of paper, after the first operation.

Also, the present invention is a stapler suitable for a post-processing device having a stapler for binding sheets of paper with a staple and configured to perform a post-processing on sheets of paper with an image formed thereon, wherein the stapler includes a staple striking portion for striking a staple to penetrate sheets of paper, and a clincher portion for bending staple legs of the staple penetrating the sheets of paper; wherein the clincher portion includes a pair of clinchers; wherein the pair of clinchers are configured to perform a first operation, in which the pair of the clinchers move along a surface direction of the sheets of paper to approach each other, and a second operation, in which the pair of clinchers move to approach the sheets of paper, after the first operation.

Further, the present invention is a stapler suitable for an image formation system including an image formation device configured to form an image on a sheet of paper and then to output the sheet of paper, and the post-processing device as described above connected to the image formation device and configured to perform a post-processing on the sheets of paper.

According to the present invention, the pair of clinchers bend the staple legs of the staple penetrating the sheets of paper by the first operation, in which the pair of the clinchers move along the surface direction of the sheets of paper to approach each other, and the second operation, in which the pair of clinchers move to approach the sheets of paper.

According to the present invention, it is possible to realize a stabilized bent shape of the staple legs. Also, it is possible to keep a height of the clincher portion lower, thereby keeping a height of the stapler lower.

### BRIEF DESCRIPTION OF THE DRAWINGS

FIG. 1 is a configuration view showing an outline of an image formation system of the present embodiment.

FIG. 2 is configuration view showing one example of a post-processing device of the present embodiment.

FIGS. 3A to 3D are explanatory views showing one example of an operation of binding sheets of paper with a staple.

FIG. 4 is a side view showing one example of a stapler of the present embodiment.

FIG. 5 is a perspective view showing the example of the stapler of the present embodiment.

FIG. 6 is a perspective view showing one example of a cutting portion and a clincher portion.

FIGS. 7A to 7C are explanatory views showing an exemplary operation of the cutting portion and the clincher portion.

FIGS. 8A to 8C are explanatory views showing an exemplary operation of the cutting portion and the clincher portion.

FIGS. 9A and 9B are explanatory views showing an exemplary operation of the clincher portion.

FIGS. 10A and 10B are explanatory views showing an exemplary operation of the clincher portion.

### DETAILED DESCRIPTION

Hereinafter, embodiments of a stapler according to the present invention, a post-processing device having the stapler mounted thereon and an image formation system having the post-processing device will be described with reference to the accompanying drawings.

<Exemplary Configuration of Image Formation System and Post-Processing Device>

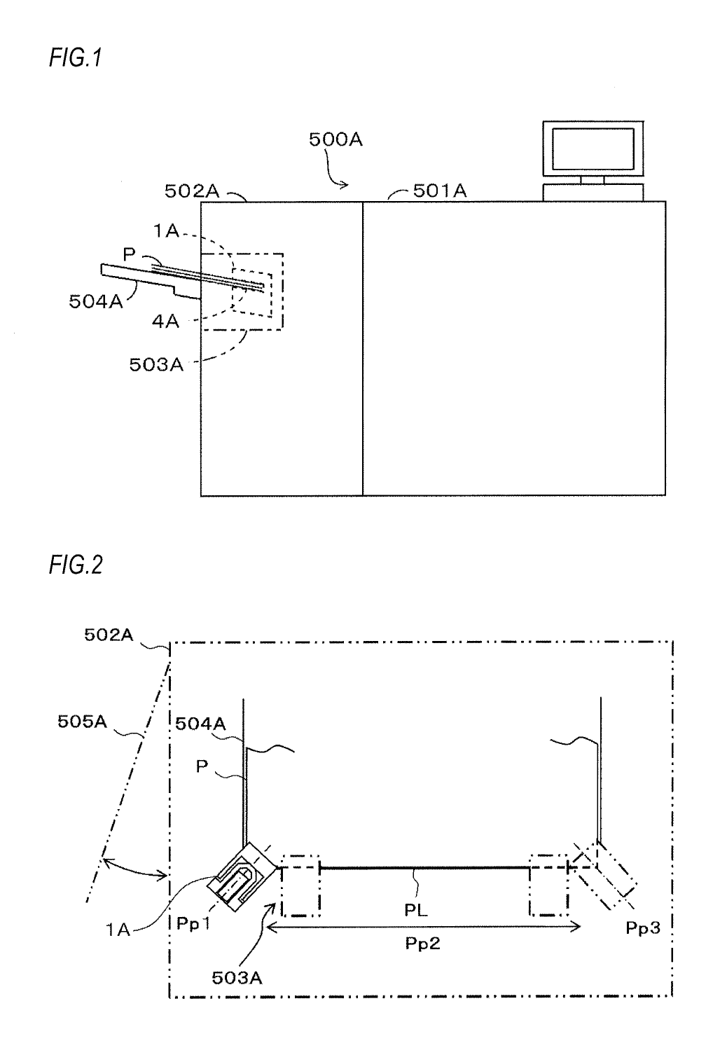

FIG. 1 is a configuration view showing an outline of an image formation system of the present embodiment, and FIG. 2 is a configuration view showing one example of a post-processing device of the present embodiment.

The image formation system 500A of the present embodiment has an image formation device 501A and a post-processing device 502A capable of performing at least one kind of processing. The image formation device 501A is configured to form an image on a sheet of paper P fed from a paper feeding portion (not shown), which is provided inside or outside the device, and then to output the sheet of paper P. In the present example, the image formation device 501A is configured to form an image on the sheet of paper P by forming an electrostatic latent image by scanning exposure, developing the electrostatic latent image by a toner, and then transferring and fixing the toner onto the sheet of paper.

The post-processing device 502A of the present embodiment has a stapler 1A, as described below, on a binding portion 503A thereof. The binding portion 503A has a stacking portion 504A in which sheets of paper P outputted from the image formation device 501A are stacked.

FIG. 2 is a view of the binding portion 503A of the post-processing device 502A as viewed from an upper side of the paper surface in FIG. 1. The stapler 1A is configured to be moved to a first position Pp1 where the sheets of paper P stacked in the stacking portion 504A are bound at one corner, a second position Pp2 where the sheets of paper P are bound at any location along a side PL thereof, and a third position Pp3 where the sheets of paper P are bound at another corner, by a moving unit (not shown). In the present example, the position Pp1 also serves as a reference position, which is a home position (HP), and an openable and closable door 505A is provided near thereto.

<Exemplary Operation of Binding Sheets of Paper with Staple>

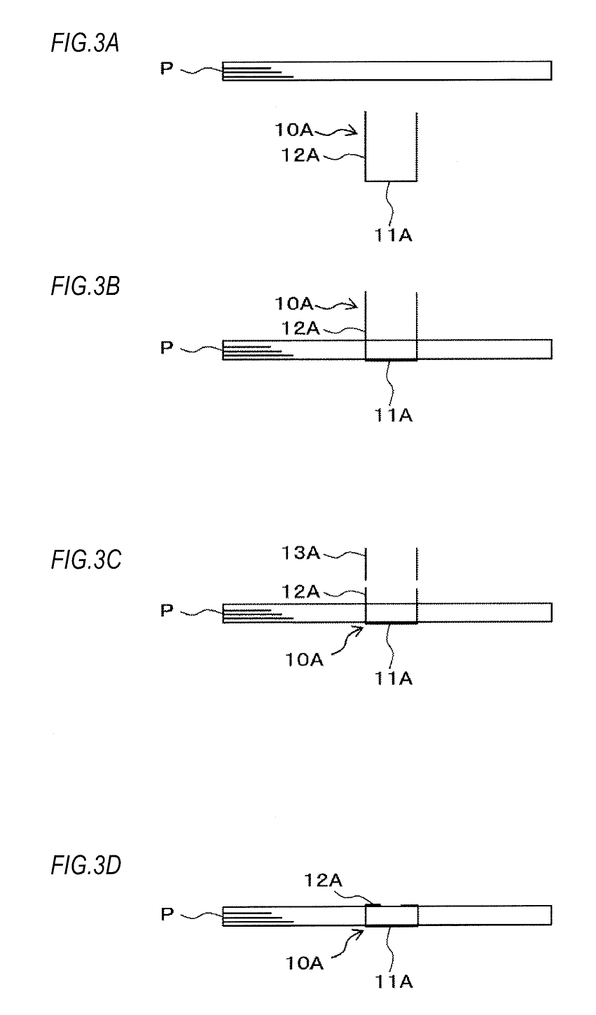

FIG. 3 is an explanatory view showing one example of an operation of binding sheets of paper with a staple. As shown in FIG. 3A, a staple 10A has staple legs 12A formed by bending both ends of a staple crown 11A toward one direction. That is, the staple 10A is shaped in a generally U-shape.

As shown in FIG. 3B, the staple 10A is configured such that as the staple crown 11A is pressed, the staple legs 12A penetrate sheets of paper P and then the staple crown 11 A comes in contact with the sheets of paper P. In the staple 10A of which the staple legs 12A have penetrated the sheets of paper P, as shown in FIG. 3C, surplus parts of the staple legs 12A which are to overlap with each other when the staple legs 12A are bent are cut as cut staples 13A. Meanwhile, a configuration for receiving the cut staples 13A cut from the staple legs 12A will be described below.

In the staple 10A of which the staple legs 12A have been cut into a predetermined length, as shown in FIG. 3D, the staple legs 12A penetrating the sheets of paper P are bent and thus the sheets of paper P are bound with the staple 10A.

### Exemplary Configuration of the Present Embodiment

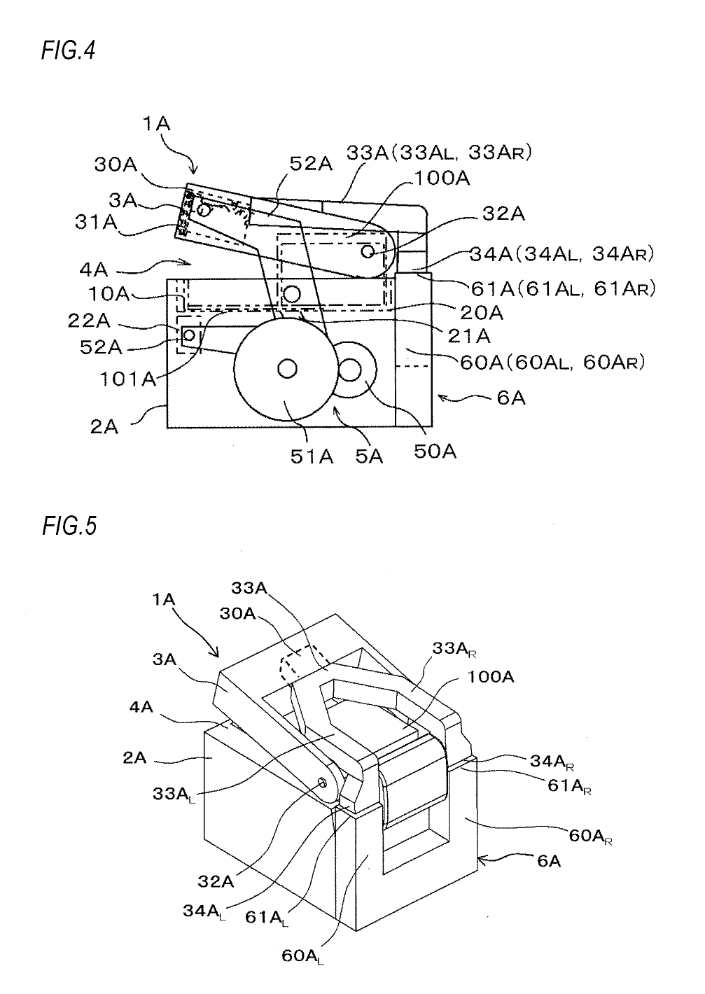

FIG. 4 is a side view showing one example of a stapler of the present embodiment, and FIG. 5 is a perspective view showing the example of the stapler of the present embodiment.

The stapler 1A of the present embodiment includes a staple striking unit 2A for supplying and striking a staple 10A, and a binding unit 3A for binding sheets of paper P with the staple 10A by cutting staple legs 12A of the staple 10A as shown in FIG. 3C and then bending the staple legs 12A as shown in FIG. 3D in cooperation with the staple striking unit 2A.

The staple striking unit 2A is an example of a staple striking portion and has a receiving portion 20A configured to allow a staple cartridge 100A, which is a staple receiving portion in which staples 10A are received, to be removably attached thereon, a feeding portion 21A for feeding a staple 10A from the staple cartridge 100A, and a striking portion 22A for driving the staple 10A into sheets of paper P.

In the present example, staples 10A are provided as a staple sheet 101A, in which a plurality of linear staples 10A are integrated by bonding, and a plurality of staple sheets 101A are stacked and received in the staple cartridge 100A. The striking portion 22A is configured to strike one staple 10A of the staple sheet 101A, which is located at the most leading end in a conveying direction thereof, and at the same time to shape a second, and possibly a third, staple 10A into a generally U-shape as shown in FIG. 3A and the like. Alternatively, the staple cartridge 100A may be supplied in a form in which staple sheets 101A are stored in a detachable refill.

The binding unit 3A is an example of a binding portion. The biding unit 3A has a cutting portion 30A and clincher portion 31A. The cutting portion 30A is configured to cut staple legs 12A of the staple 10A, which have penetrated sheets of paper P, into a predetermined length. The clincher portion 31A is configured to bend the staple legs 12A of the staple 10A, which have penetrated the sheets of paper P and have been cut into the predetermined length, toward the sheets of paper P. The clincher portion 31A is provided at a location opposing the striking portion 22A for the stapler 10A. The cutting portion 30A is arranged at a location close to the clincher portion 31A.

The stapler 1A has a paper clamping portion 4A for clamping sheets of paper P between the staple striking unit 2A and the binding unit 3A. The paper clamping portion 4A is provided on one side of the stapler 1A, on which the striking portion 22A of the staple striking unit 2A and the clincher portion 31A of the binding unit 3A are provided.

In the post-processing device 502A, as shown in FIG. 1, sheets of paper P are aligned and stacked using an inclination of the stacking portion 504A. Therefore, the stapler 1A is mounted to be inclined in such a direction that an opening thereof; through which the sheets of paper P are inserted into and withdrawn from the paper clamping portion 4A, is oriented upward, or is horizontally mounted.

As shown in FIG. 2, the stapler 1A is moved inside the post-processing device 502A due to changing of binding positions and the like, and thus an orientation thereof is not kept constant. Therefore, a side on which the paper clamping portion 4A is provided is referred to as a front side of the stapler 1A, and a side opposite to the side on which the paper clamping portion 4A is provided is referred to as a rear side thereof. Also, a side on which the binding unit 3A is provided is referred to as an upper side of the stapler 1A, and a side on which the staple striking unit 2A is provided is referred to as a lower side of the stapler 1A.

The paper clamping portion 4A has a shape, which is opened on front, right and left sides of the stapler 1A, so that a binding location on the sheets of paper P at which the sheets of paper P are bound with the staple 10A can be positioned between the striking portion 22A and the clincher portion 31A.

The stapler 1A has a drive unit 5A for driving the feeding portion 21A and the striking portion 22A of the staple striking unit 2A, the binding unit 3A, the cutting portion 30A and the clincher portion 31A of the binding unit 3A.

The drive unit 5A has a cam 51A driven by a motor 50A provided in the staple striking unit 2A, a link portion 52A for transferring an operation of the cam 51A to each part, and the like

According to the stapler 1A, as an operation of the cam 51A is transferred to the binding unit 3A via the link portion 52A and the like, the staple striking unit 2A and the binding unit 3A are moved relative to each other in separating/contacting directions, in which they separate from and contact with each other. In the present example, the binding unit 3A is moved relative to the staple striking unit 2A in the separating/contacting directions by a rotation operation thereof about a shaft 32A.

According to the stapler 1A, the binding unit 3A is moved in a direction approaching the staple striking unit 2A by an operation, in which the cam 51A rotates in one direction, and thus the paper clamping portion 4A clamps sheets of paper P at a predetermined timing. Also, according to the stapler 1A, the binding unit 3A is moved in a direction separating from the staple striking unit 2A at a predetermined timing by an operation, in which the cam 51A further rotates in one direction, and thus clamping of the sheets of paper P by the paper clamping portion 4A is released.

Further, according to the stapler 1A, an operation of the cam 51A is transferred to the feeding potion 21A and the striking portion 22A via the link portion 52A and the like. Therefore, due to an operation in which the cam 51A rotates in one direction, staples 10A received in the staple cartridge 100A are fed by the feeding portion 21A, and then one of the fed staples 10A, which is located at the most leading end thereof, is driven into sheets of paper P, which are clamped by the paper claiming portion 4A, by the striking portion 22A. As a result, staple legs 12A of the staple 10A penetrate the sheets of paper P. Also, shaping of a second, and possibly a third, staple 10A is performed.

Further, according to the stapler 1A, an operation of the cam 51A is also transferred to the cutting portion 30A and the clincher portion 31A via the link portion 52A and the like. Therefore, due to an operation in which the cam 51A rotates in one direction, the staple legs 12A of the staple 10A penetrating the sheets of paper P are cut into a predetermined length by the cutting portion 30A, and then the staple legs 12A of the staple 10A, which have been cut into the predetermined length, are bent by the clincher portion 31A.

The stapler 1A has a cut staple receiving portion 6A for receiving cut staples 13A cut by the cutting portion 30A. The cut staple receiving portion 6A is removably attached on the stapler 1A on a rear side of the stapler 1A opposite to a side thereof, on which the paper clamping portion 4A is provided.

The cut staple receiving portion 6A has two collecting paths 60A_{L}, 60A_{R}. When the cut staple receiving portion 6A is attached on the stapler 1A, the two collecting paths 60A_{L}, 60A_{R} are arranged on both sides of the receiving portion 20A, so that an attaching and detaching path, along the staple cartridge 100A is attached on and detached from the receiving portion 20A, is not blocked.

The cut staple receiving portion 6A is sized such that even if staple legs 12A of the maximum number of staples 10A which can be received in the stapler cartridge 100A are cut into the maximum length, all the cut staples 13A can be received therein.

Also, the cut staple receiving portion 6A is configured such that regardless of positions of the stapler 1A inside the post-processing device 502A, a main body portion of the cut staple receiving portion 6A are positioned below either or both of the collecting path 60A_{L} or the collecting path 60A_{R}.

The stapler 1A has a discharging path 33A provided in the binding unit 3A for guiding the cut staples 13A, which are cut by the cutting portion 30A, to the cut staple receiving portion 6A. In the present embodiment, the discharging path 33A is configured such that one discharging path 33A communicated with the cutting portion 30A is divided into two discharging paths 33A_{L}, 33A_{R}, which are arranged on both sides of the receiving portion 20, thereby preventing an attaching and detaching path, along which the staple cartridge 100A is attached on or detached from the receiving portion 20A, from being blocked.

In the stapler 1A, a discharging port 34A_{L} of one discharging path 33A_{L}, is communicated with a collecting port 61A_{L} of one collecting path 60A_{L} of the cut staple receiving portion 6A, and a discharging port 34A_{R} of the other discharging path 33A_{R} is communicated with a collecting port 61A_{R} of the other collecting path 60A_{R} of the cut staple receiving portion 6A.

Therefore, a cut staple 13A passing though the one discharging path 33A_{L} from the cutting portion 30A is collected in the cut staple receiving portion 6A by passing through the collecting path 60A_{L} via the collecting port 61A_{L}. Also, a cut staple 13A passing though the other discharging path 33A_{R} from the cutting portion 30A is collected in the cut staple receiving portion 6A by passing through the collecting path 60A_{R} via the collecting port 61A_{R}.

The discharging path 33 is configured such that regardless of positions of the stapler 1A inside the post-processing device 502A, the discharging ports 34A_{L} and/or 34A_{R} of at least one of the discharging path 33A_{L} and the discharging path 33A_{R} is lower than the cutting portion 30A.

The discharging path 33A (33A_{L}, 33A_{R}) is provided in the binding unit 3A and thus is moved by a rotation operation of the binding unit 3A about the shaft 32A. In contrast, the cut staple receiving portion 6A is attached on the staple striking unit 2A and is not moved relative to the binding unit 3A.

Therefore, the discharging port 34A_{L}, of the one discharging path 33A_{L} and the discharging port 34A_{R} of the other discharging path 33A_{R} are arranged near to the shaft 32, so that an amount of movement of the discharging port 34A_{L}, 34A_{R} due to a rotation operation of the binding unit 3A about the shaft 32A is kept small.

Also, the discharging port 34A_{L} of the one discharging path 33A_{L} is configured to enter the one collecting port 61A_{L} of the cut staple receiving portion 6A and also to be moveable within a range of an opening of the collecting port 61A_{L}. Similarly, the discharging port 34A_{R} of the other discharging path 33A_{R} is configured to enter the other collecting port 61A_{R} of the cut staple receiving portion 6A and also to be moveable within a range of an opening of the collecting port 61A_{R}.

### Exemplary Configuration of Cutting Portion and Clincher Portion of the Present Embodiment

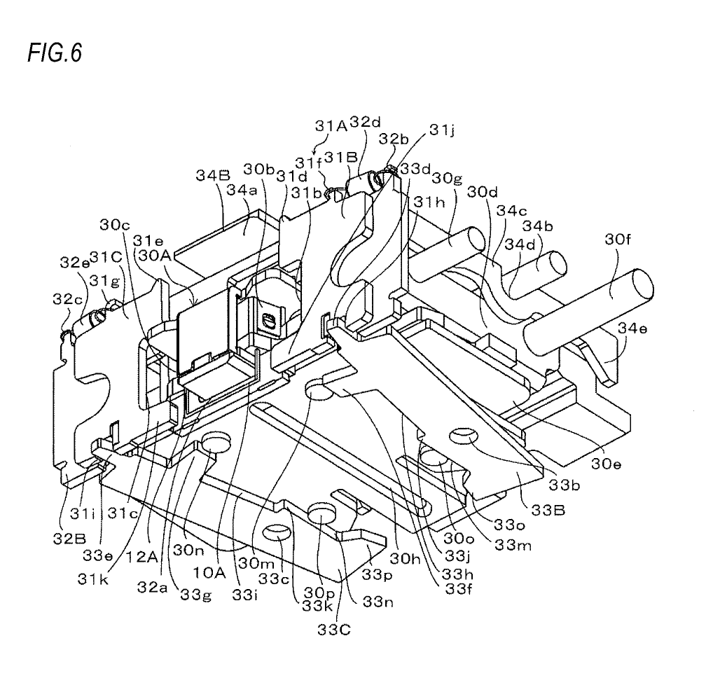

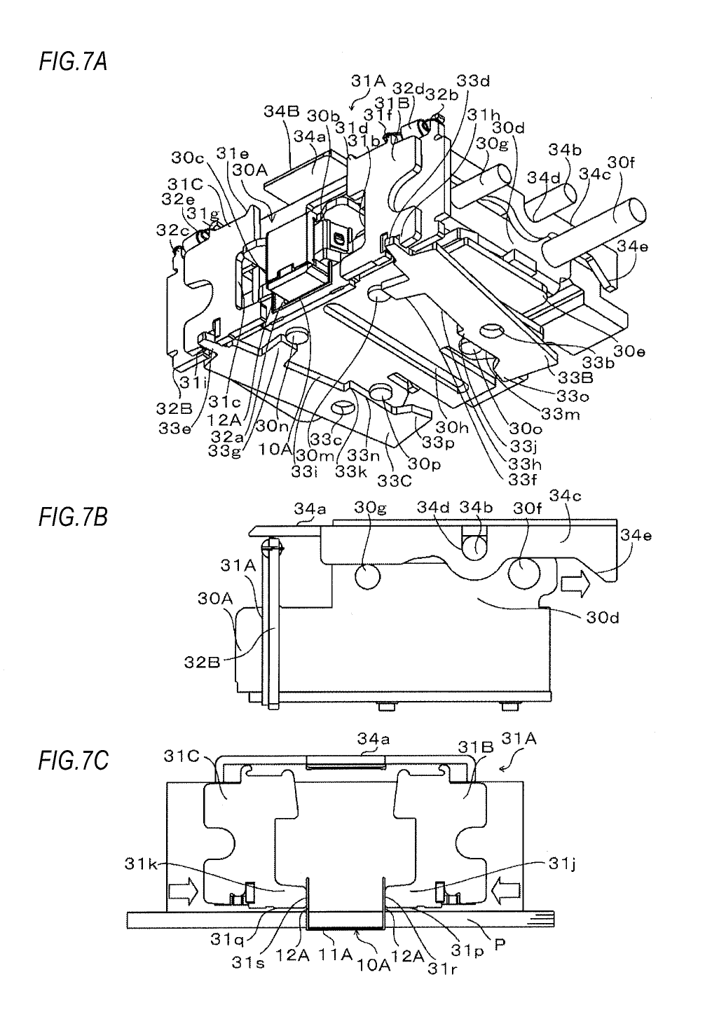

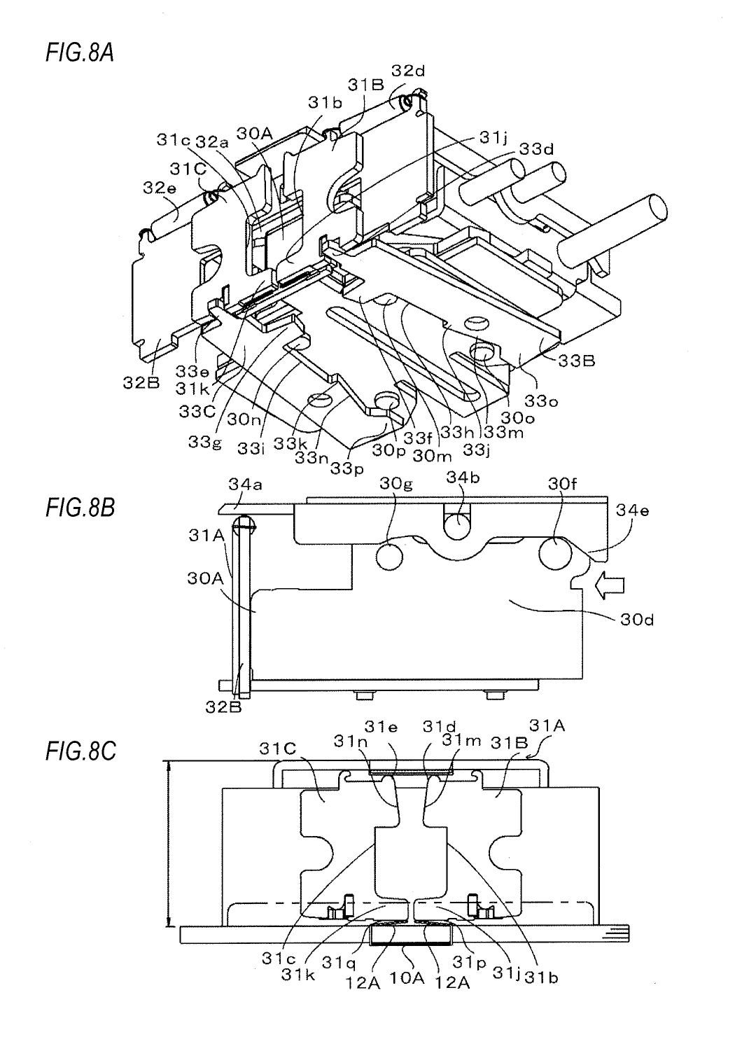

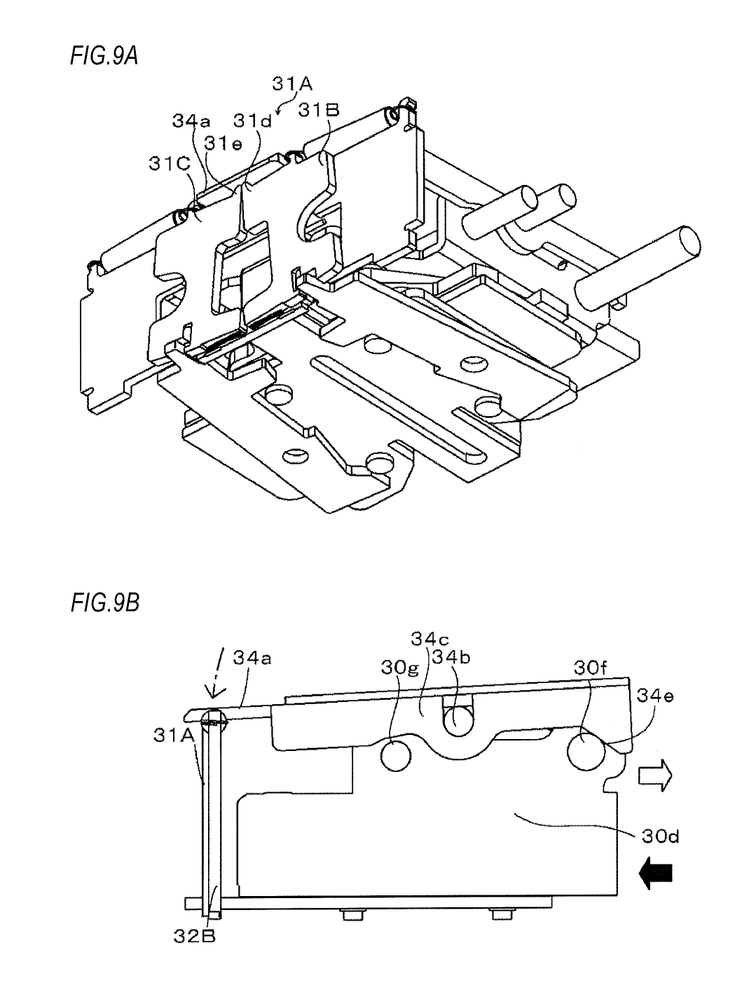

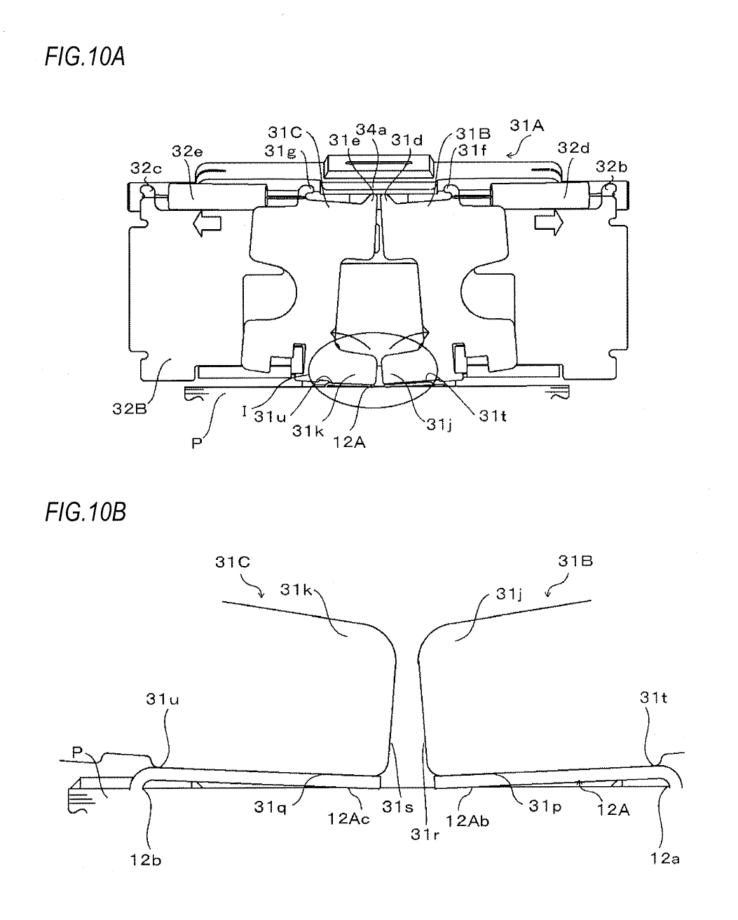

FIG. 6 is a perspective view showing one example of the cutting portion and the clincher portion of the present embodiment, FIGS. 7A to 7C and 8A to 8C are a perspective view, a side view and a schematic front plan view showing an exemplary operation of the cutting portion and the clincher portion of the present embodiment. FIGS. 9A and 9B are perspective view and a side view showing an exemplary operation of the clincher portion. FIGS. 10A and 10B are front plan views showing an exemplary operation of the clincher portion. Meanwhile, for convenience of explanation, sheets of paper P are omitted in FIGS. 7A, 8A and 9A.

As shown in FIG. 6, the cutting portion 30A of the present embodiment has a staple leg cutting member 30b, 30c for cutting surplus parts of staple legs 12A, and a moving member 30d for moving the staple leg cutting member 30b, 30c.

Also, the clincher portion 31A of the present embodiment has a pair of clinchers 31B, 31C for bending the staple legs 12A along a surface direction of sheets of paper P, a support plate 32B for movably supporting the clinchers 31B, 31C, a clincher link 33B for moving the clincher 31B, a clincher link 33C for moving the clincher 31C, and a pressing portion 34B for pressing upper portions of the clinchers 31B, 31C while the clinchers 31B, 31C are close to each other.

As shown in FIG. 3B, the staple leg cut members 30b, 30c are configured to cut staple legs 12A of a staple 10A, which are formed by bending both ends of a staple crown 11 A toward one direction and penetrate sheets of paper P, into a predetermined length suitable to the number of sheets of paper P.

The moving member 30d has a support plate 30e provided on a bottom surface of the cutting portion 30A and moving shafts 30f, 30g provided on sides of the cutting portion 30A.

The support plate 30e has a long hole 30h provided at the center thereof to extend in a direction perpendicular to the support plate 32B, and protrusions 30m, 30n, 30o, 30p protruding downward from the support plate 30e. An attachment member (not shown) is attached on the moving member 30d, and the attachment member is also attached on the binding unit 3A through the inside of the long hole 30h, so that the moving member 30d can move along the long hole 30h. The protrusions 30m, 30n, 30n, 30o are arranged at equal distances from the long hole 30h. The protrusions 30m, 30n are positioned to be perpendicular to the long hole 30h and also for the long hole 30h to be positioned therebetween, and the protrusions 30o, 30p are positioned to be perpendicular to the long hole 30h and also for the long hole 30h to be positioned therebetween. The protrusions 30m, 30n protrude from the vicinity of a front surface of the support plate 32B, and the protrusions 30o, 30p protrude from locations, which are located more rearward than the protrusions 30m, 30n.

Each of the moving shafts 30f, 30g is operatively connected to the link portion 52A via a link member (not shown), so that an operation of the cam 51A is transferred to the moving shafts 30f, 30g. When the drive unit 5A drives the cam 51A, the moving shafts 30f, 30g are moved forward and backward in a direction perpendicular to the support plate 32B via the link portion 52A and the like. As the moving shafts 30f, 30g are moved forward and backward, the cutting portion 30A is also moved forward and backward in a direction perpendicular to the support plate 32B.

The clinchers 31B, 31C are plate members of the same shape, which are symmetrically arranged to laterally oppose each other. The clincher 31B has a recess 31b provided on an edge thereof opposing the clincher 31C, a protrusion 31d provided above the recess 31b, a claw portion 31f provided above the protrusion 31d but on a side thereof away from the clincher 31C, a recess 31h provided on a lower edge of the clincher 31B, and a protrusion 31j provided below the recess 31b and protruding toward the clincher 31C.

The clincher 31C has a recess 31c provided on an edge thereof opposing the clincher 31B, a protrusion 31e provided above the recess 31c, a claw portion 31g provided above the protrusion 31e but on a side thereof away from the clincher 31B, a recess 31i provided on a lower edge of the clincher 31C, and a protrusion 31k provided below the recess 31c and protruding toward the clincher 31B.

The protrusions 31d, 31e protrude upward relative to an upper end of the support plate 32B. As shown in FIG. 8C, the protrusion 31j protrudes more toward the clincher 31C than an edge portion 31m above the recess 31b. The protrusion 31k protrudes more toward the clincher 31B than an edge portion 31n above the recess 31c. The edge portions 31m, 31n are inclined in such a direction that the edge portions 31m, 31n are farther away from each other as they go upward.

The support plate 32B is fixed to the binding unit 3A, as shown in FIG. 4, to be parallel to the front surface of the binding unit 3A. As shown in FIG. 6, the support plate 32B has an opening 32a provided at the center of the support plate 32B and configured to allow the cutting portion 30A to come in and out while moving forward and backward, and claw portions 32b, 32c provided near to upper ends of both sides of the support plate 32B. The claw portion 32b is connected with the claw portion 31f on the upper end of the clincher 31B via a spring 32d, and the claw portion 32c is connected with the claw portion 31g on the upper end of the clincher 31C via a spring 32e.

In a state where the clinchers 31B, 31C are separated from each other, the cutting portion 30A protrudes through the opening 32a of the support plate 32B and thus is positioned at a first position, where the cutting portion 30A is advanced into an operation region of the clinchers 31B, 31C on the front surface side thereof. In a state where the clinchers 31B, 31C are close to each other, the cutting portion 30A is retracted into the opening portion 32a and thus is positioned at a second position, where the cutting portion 30A is retracted from the operation region of the clinchers 31B, 31C.

The clincher links 33B, 33C are plate members of the same shape, which are symmetrically arranged to laterally oppose each other. The clincher link 33B is pivotally supported on the binding unit 3A about a shaft member (not shown) inserted through a pivot hole 33b. The clincher link 33B is configured to movably support the clincher 31B relative to the support plate 32B. The clincher link 33B has a protrusion 33d inserted in the recess 31h and then protruding toward the front surface side, a protrusion 33f protruding from a location thereon opposing the clincher link 33C, a recess 33h adjacent to a rear surface side of the protrusion 33f, a protrusion 33j adjacent to a rear surface side of the recess 33h, an inclined portion 33m obliquely cut out in such a direction that the inclined portion 33m is farther away from the clincher link 33C as it goes from the protrusion 33j toward the rear surface side, and a protrusion 33o adjacent to a rear surface side of the inclined portion 33m.

The clincher link 33C is pivotally supported on the binding unit 3A about a shaft member (not shown) inserted through a pivot hole 33c. The clincher link 33C is configured to movably support the clincher 31C relative to the support plate 32B. The clincher link 33C has a protrusion 33e inserted in the recess 31i and then protruding toward the front surface side, a protrusion 33g protruding from a location thereon opposing the clincher link 33B, a recess 33i adjacent to a rear surface side of the protrusion 33g, a protrusion 33k adjacent to a rear surface side of the recess 33i, an inclined portion 33n obliquely cut out in such a direction that the inclined portion 33n is farther away from the clincher link 33B as it goes from the protrusion 33k toward the rear surface side, and a protrusion 33p adjacent to a rear surface side of the inclined portion 33n.

As the moving shafts 30f, 30g moves forward and backward, locations where the clincher link 33B comes in contact with the protrusions 30m, 30o are changed and thus the clincher link 33B are pivoted. Also, as the moving shafts 30f, 30g moves forward and backward, locations where the clincher link 33C comes in contact with the protrusions 30n, 30p are changed and thus the clincher link 33C are pivoted.

The pressing portion 34B is provided at a location where the pressing portion 34B covers over the cutting portion 30A and the support plate 32B. The pressing portion 34B has a pressing plate 34a provided over the cutting portion 30A and the support plate 32B, a pivot shaft 34b for the pressing plate 34a, and support members 34c for the pivot shaft 34b.

The pressing plate 34A protrudes from above the opening 32a toward the front surface side. When the clincher 31B, 31C are positioned at an initial position where the clinchers 31B, 31C are away from each other, a space is formed the pressing plate 34a and the upper end of the support plate 32B.

As shown in FIG. 7B, the pivot shaft 34b is provided to be parallel to the moving shafts 30f, 30g at a location where the pivot shaft 34b is sandwiched between the cutting portion 30A and the pressing plate 34a.

The support members 34c have a hole portion 34d for pivotally supporting the pivot shaft 34b, and an inclined portion 34 provided more toward the rear surface side than the hole portion 34d and inclined downward as it goes toward the rear surface side. The support members 34c are integrated with the pressing plate 34a to be pivoted about the pivot shaft 34b. Thus, the cutting portion 30A and the clincher portion 31A are operatively connected to each other via the clincher links 33B, 33C.

### Exemplary Operation of Stapler of the Present Embodiment

In FIG. 7A, sheets of paper P are omitted for convenience of explanation, but a state, where as shown in FIG. 3C, staple legs 12A of a stale 10A penetrating sheets of paper P are cut into a predetermined length suitable to the number of sheets of paper P by the staple leg cutting members 30b, 30c of the cutting portion 30A, is shown. This state is a state where the cutting portion 30A is moved farthest toward the front surface side and also the inclined portion 34e and the moving shaft 30f are positioned to be farthest away from each other. The cutting portion 30A is positioned at the first position, where the cutting portion 30A is advanced through the opening 32a of the support plate 32B into the operation region of the clinchers 31B, 31C on the front surface side. The recess 31b of the clincher 31B and the recess 31c of the clincher 31C are moved aside from the cutting portion 30A.

As shown in FIG. 7A, the protrusion 30m of the support plate 30e is in contact with a distal end of the protrusion 33f of the clincher link 33B, and the protrusion 30o is in contact with the inclined portion 33m to be close to the protrusion 33j. The protrusion 30n of the support plate 30e is in contact with a distal end of the protrusion 33g of the clincher link 33C, and the protrusion 30p is in contact with the inclined portion 33n to be close to the protrusion 33k. Since the protrusion 33d of the clincher link 33B and the protrusion 33e of the clincher link 33C are positioned to be farthest away from each other, the clinchers 31B, 31C are also positioned to be farthest away from each other.

The sheets of paper P are clamped by the paper clamping portion 4A shown in FIG. 4, and as shown in FIG. 7C, the staple crown 11A of the staple 10A is positioned below the sheets of paper P. The staple legs 12A protrude upward relative to the sheets of paper P and also protrude upward relative to the protrusions 31j, 31k of the clinchers 31B, 31C. A lower surface 31p of the protrusion 31j of the clincher 31B and a lower surface 31q of the protrusion 31k of the clincher 31C are positioned to be parallel to the surface of the sheets of paper P. Opposing edges 31r, 31s of the protrusion 31j and the protrusion 31k are positioned to be perpendicular to the surface of the sheets of paper P.

When the drive unit 5A shown in FIG. 4 drives the cam 51A, an operation of the cam 51A is transferred to the moving shaft 30f, 30g via the link portion 52A and a link member (not shown). Therefore, as shown by an outlined arrow in FIG. 7B, the drive unit 5A moves the moving shafts 30f, 30g in a direction perpendicular to the support plate 32B so that the moving member 30d approaches the inclined portion 34e.

As the moving shafts 30f, 30g are moved toward the rear surface side in the direction perpendicular to the support plate 32B, the cutting portion 30A are moved more rearward than the opening 32a of the support plate 32B as shown in FIG. 8A. When the moving shaft 30f and the inclined portion 34e approach each other as shown in FIG. 8B, the cutting portion 30A is moved to the second position, where the cutting portion 30A is retracted from the operation region of the clinchers 31B, 31C, as shown in FIG. 8A.

As the moving member 30d is moved, locations where the clincher links 33B, 33C come in contact with the protrusions 30m, 30n, 30o, 30p of the support plate 30e are changed. The protrusion 30m is in contact with a side surface of the protrusion 33f facing the recess 33h, and the protrusion 30o is positioned close to the inclined portion 33m and the protrusion 33o. The protrusion 30n is in contact with a side surface of the protrusion 33g facing the recess 33i, and the protrusion 30p is positioned close to the inclined portion 33n and the protrusion 33p.

In particular, as the protrusion 30m is moved from the state, where the protrusion 30m is in contact with the distal end of the protrusion 33f as shown in FIG. 7A, to the state, where the protrusion 30m is in contact with the side surface of the protrusion 33f facing the recess 33h as shown in FIG. 8B, the protrusion 33d is pivoted to be close to the clincher link 33C. Therefore, as shown by an outlined arrow in FIG. 7C, the clincher 31B is moved along a surface direction of the sheets of paper P to approach the clincher 31C. Also, as the protrusion 30n is moved from the state, where the protrusion 30n is in contact with the distal end of the protrusion 30g as shown in FIG. 7A, to the state, where the protrusion 30n is in contact with the side surface of the protrusion 30g facing the recess 33i as shown in FIG. 8B, the protrusion 33e is pivoted to be close to the clincher link 33B. Therefore, as shown by an outlined arrow in FIG. 7C, the clincher 31C is moved along a surface direction of the sheets of paper P to approach the clincher 31B.

As the clinchers 31B, 31C approach each other, a distance between the claw portion 31f and the claw portion 32b is increased to stretch the spring 32d, and a distance between the claw portion 31g and the claw portion 32c is increased to stretch the spring 32e.

In this way, a first operation, in which the clinchers 31B, 31C approach each other along the surface direction of the sheets of paper P, is performed in accordance with movement of the cutting portion 30A from the first position to the second position. Due to the first operation, the protrusions 31j, 31k bend the staple legs 12A toward the surface direction of the sheets of paper P as shown in FIG. 8C. The sheets of paper P and the lower surface 31p of the protrusion 31j of the clincher 31B become parallel to each other, and also the sheets of paper P and the lower surface 31q of the protrusion 31k of the clincher 31C become parallel to each other. The lower surfaces 31p, 31q are slightly spaced from the sheets of paper P. Therefore, the distal ends of the staple legs 12A are also bent to be slightly spaced from the sheets of paper P.

When the drive unit 5A shown in FIG. 4 further drives the cam 51A, an operation of the cam 51A is transferred to the moving shaft 30f, 30g via the link portion 52A and the link member (not shown). If the operation of the cam 51A is transferred to the moving shafts 30f, 30g, as shown by an outlined arrow in FIG. 9B, the moving member 30d is further moved toward the rear surface side in the direction perpendicular to the support plate 32B. Due to the movement of the moving member 30d, the moving shaft 30f pushes up the inclined portion 34e and thus as shown by an one-dotted chain line arrow in FIG. 9B, the pressing plate 34a is pivoted about the pivot shaft 34b in a direction toward the clincher portion 31A while being integrated with the support members 34c

As the pressing plate 34a is pivoted, the pressing plate 34a presses the protrusion 30d of the clincher 31B and the protrusion 31e of the clincher 31C as shown in FIG. 10A. As a result, the clinchers 31B, 31C approach the sheets of paper P, and thus a second operation, in which the clinchers 31B, 31C are pivoted along the support plate 32B so that the protrusions 31d, 31e approach each other, is performed.

FIG. 10B is a detailed view of a section I in FIG. 10A. As shown in FIG. 10B, a pivot fulcrum 31t of the clincher 31B is a pivot fulcrum, as which a point thereon in contact with the corresponding staple leg 12A serves, and is located on the lower surface 31p of the protrusion 31j in contact with one staple leg 12Ab. The pivot fulcrum 31t is a point near to a root of the bent staple leg 12Ab and is located more toward a distal end of the staple leg 12Ab than an inner side 12a of the root of the staple leg 12Ab. The lower surface 31p presses a region of the staple leg 12Ab ranging from the pivot fulcrum 31t to the distal end thereof while being pivoted, so that the staple leg 12Ab is bent to extend along the surface direction of the sheets of paper P.

A pivot fulcrum 31u of the clincher 31C is a pivot fulcrum, as which a point thereon in contact with the corresponding staple leg 12A serves, and is located on the lower surface 31q of the protrusion 31k in contact with the other staple leg 12Ac. The pivot fulcrum 31u is a point near to a root of the bent staple leg 12Ac and is located more toward a distal end of the staple leg 12Ac than an inner side 12b of the root of the staple leg 12Ac. The lower surface 31q presses a region of the staple leg 12Ac ranging from the pivot fulcrum 31u to the distal end thereof while being pivoted, so that the staple leg 12Ac is bent to extend along the surface direction of the sheets of paper P. A width between the pivot fulcrums 31t, 31u, i.e., a distance between the pivot fulcrums is set to be narrower than a width between inner sides 12a, 12b of the staple crown 11A shown in FIG. 3A. Therefore, as the staple legs 12Ab, 12Ac are bent to extend along the surface direction of the sheets of paper P, the staple legs 12A penetrating the sheets of paper P are bent as shown in FIG. 3D, so that the sheets of paper P are bound with the staple 10A. At this time, the clinchers 31B, 31C are in contact with a region of the respective staple legs 12A of the staple, which penetrate the sheets of paper P and are bent, ranging from the pivot fulcrums 31t, 31g to the distal ends thereof.

In the state where the protrusions 31d, 31e are pressed by the pressing plate 34a, as shown in FIG. 10A, the spring 32d which urges the claw portion 31f of the clincher 31B toward the claw portion 32b of the support plate 32B is further stretched, and the spring 32e which urges the claw portion 31g of the clincher 31C toward the claw portion 32c of the support plate 32B is further stretched.

When an operation of bending the staple legs 12A is completed, the drive unit 5A shown in FIG. 4 drives the cam 51A, and an operation of the cam 51A is transferred to the moving shafts 30f, 30g via the link portion 52A and the link member (not shown). As the moving shafts 30f, 30g are moved, the moving member 30d is moved to approach the support plate 32B in a direction perpendicular thereto as shown by a solid arrow in FIG. 9B. Pushing up of the inclined portion 34e by the moving shaft 30f is released, and thus the pressing plate 34a is pivoted about the pivot shaft 34b in a direction opposite to the one-dotted chain line arrow in FIG. 9B while being integrated with the support members 34c, and is moved away from the clincher portion 31A.

When the pressing plate 34a is separated from the protrusion 31d of the clincher 31B and the protrusion 31e of the clincher 31C, the stretched springs 32d, 32e try to contract as shown by an outlined arrow in FIG. 10A. Due to tensile forces of the springs 32d, 32e, the clincher 31B and the clincher 31C, which have pressed the staple legs 12A toward the sheets of paper P, are pivoted about the pivot fulcrums 31t, 31u in directions separating from the staple legs 12A as shown by solid arrows in the figure. As shown in FIG. 8C, the sheets of paper P and the lower surface 31p of the protrusion 31j of the clincher 31B become parallel to each other, and also the sheets of paper P and the lower surface 31q of the protrusion 31k of the clincher 31C become parallel to each other.

The drive unit 5A shown in FIG. 4 drives the cam 51A and thus moves the moving shafts 30f, 30g in a direction perpendicular to and approaching the support plate 32B, as shown by an outlined arrow in FIG. 8B, via the link portion 52A and the link member (not shown). As the moving shafts 30f, 30g are moved in the direction approaching the support plate 32B, the moving member 30d is separated from the inclined portion 34e.

As the moving member 30d is moved, the stretched springs 32d, 32e shown in FIG. 8A try to contract. Due to forces which are caused by the springs 32d, 32e trying to contract, the clinchers 31B, 31C are pulled in directions away from each other.

As the moving member 30d are moved, the clincher links 33B, 33C are pivoted so that locations where the clincher links 33B, 33C come in contact with the protrusions 30m, 30n, 30o, 30p of the support plate 30e are changed.

As the clincher links 33B, 33C are pivoted, the protrusion 33d of the clincher link 33B and the protrusion 33e of the clincher link 33C are moved to be away from each other. Thus, the clincher 31B and the clincher 31C are moved along the surface direction of the sheets of paper P in a direction opposite to the outlined arrow in FIG. 7C, so that the clincher 31B and the clincher 31C are away from each other. Further, as the moving shafts 30f, 30g are moved toward the front surface side in a direction perpendicular to the support plate 32B, the cutting portion 30A are moved toward the front surface side though the opening 32a of the support plate 32B as shown in FIG. 7A.

Then, the drive unit 5A stops moving the moving shafts 30f, 30g at a position where the moving shaft 30f and the inclined portion 34e are farthest away from each other as shown in FIG. 7A. The protrusion 30m comes in contact with the distal end of the protrusion 33f, and the protrusion 30o comes in contact with the inclined portion 33m to be close to the protrusion 33j. The protrusion 30n comes in contact with the distal end of the protrusion 33g, and the protrusion 30p is in contact with the inclined portion 33n to be close to the protrusion 33k.

In particular, as shown in FIG. 8A, since the protrusion 30o is moved from the vicinity of the protrusion 33o to the vicinity of the protrusion 33j, the clincher link 33B is pivoted so that the protrusion 30o follows the inclined portion 33m, and also the clincher link 33B is moved until the protrusion 30m comes in contact with the distal end of the protrusion 33f.

Further, since the protrusion 30p is moved from the vicinity of the protrusion 33p to the vicinity of the protrusion 33k, the clincher link 33C is pivoted so that the protrusion 30p follows the inclined portion 33n, and also the clincher link 33C is moved until the protrusion 30n comes in contact with the distal end of the protrusion 33g.

Therefore, the protrusion 33d of the clincher link 33B and the protrusion 33e of the clincher link 33C are positioned to be farthest away from each other, and thus the clincher 32B and the clincher 33C are positioned to be farthest from each other. Also, the cutting portion 30A is moved to the first position where the cutting portion 30A is advanced into the operation region of the clinchers 31B, 31C. Accordingly, the cutting portion 30A and the clincher portion 31A operates together by the clincher links 33B, 33C operatively connecting the cutting portion 30A with the clincher portion 31A.

### Exemplary Operation and Effects of Stapler of the Present Embodiment

The stapler 1A of the present embodiment is configured to bend the staple legs 12A by the first and second operations which move the clinchers 31B, 31C. Therefore, the pivot fulcrum 31t of the clincher 31B and the pivot fulcrum 31u of the clincher 31C can be provided at locations which are close to the sheets of paper P and at which they come in contact the staple legs 12Ab, 12Ac. As a result, the staple 1A can keep a height of clincher portion 31A lower, thereby achieving downsizing thereof.

According to the stapler 1A, a distance between the pivot fulcrums 31t, 31u of the clinchers 31B, 31C during the second operation is set to be narrower than a distance between the inner sides 12a, 12b, which is an inner width of the staple crown 11A of the staple 1A penetrating the sheets of paper P. Therefore, during the second operation, the lower surface 31p presses a region of the staple leg 12Ab ranging from the pivot fulcrum 31t to the distal end thereof, and thus the staple legs 12Ab is bent to extend along the surface direction of the sheets of paper P. Also, during the second operation, the lower surface 31q presses a region of the staple leg 12Ac ranging from the pivot fulcrum 31u to the distal end thereof, and thus the staple legs 12Ac is bent to extend along the surface direction of the sheets of paper P.

Thus, a contact length between the clinchers 31B, 31C and the staple legs 12A is increased. As a result, it is possible to properly bend the staple legs 12A onto the surface of the sheets of paper P, thereby inhibiting a poor binding, such as buckling, reverse bending, rising-up of staple legs or lifting of staple legs, and thus realizing a stabilized bent shape of the staple legs 12A.

Further, an operation in which the cutting portion 30A moves forward and backward between the first position, where the cutting portion 30A is advanced into the operation region of the clinchers 31B, 31C, and the second position, where the cutting portion 30A is retracted from the operation region of the clinchers 31B, 31C, an operation in which the clinchers 31B, 31C approach and separate from each other, and an operation in which the clinchers 31B, 31C approach the sheets of paper P, are operatively connected together. As a result, it is possible to keep a height of the clincher portion 31A lower without causing the cutting portion 30A and the clinchers 31B, 31C to interfere with each other, thereby achieving downsizing.

Meanwhile, although in the present embodiment, the cutting portion 30A is operatively connected to the clincher portion 31A by the clincher links 33B, 33C and thus the clincher portion 31A is moved in accordance with movement of the cutting portion 30A, the present invention is not limited thereto. The cutting portion 30A and the clincher portion 31A may be separately connected to the link portion 52A via different link members (not shown), so that the an operation of the cam 51A moves the clincher portion 31A via the link portion 52A, the link members (not shown) or the like, but not via the cutting portion 30A. Also, if the stapler 1A is configured such that staples 10A suitable to the number of sheets of paper P are loaded therein, the cutting portion 3A and the cut staple receiving portion 6A may be omitted.

Although in the present embodiment, an operation of the cam 51A is transferred to the moving shafts 30f, 30g, the present invention is not limited thereto. The pivot shaft 34b may be connected to the link portion 52A via a link member (not shown), so that the operation of the cam 51A is also transferred to the pivot shaft 34b.

Since the stapler 1A has the cut staple receiving portion 6A, the cut staples 13A can be received in the cut staple receiving portion 6A, regardless of positions of the stapler 1A inside the post-processing device 502A. Alternatively, the present invention is not limited to the configuration in which the cut staple receiving portion 6A is provided in the stapler 1A, and accordingly, the post-processing device 502A may be provided with a receiving portion for receiving the cut staples 13A.

The present invention is very suitable to be applied to a stapler equipped in a post-processing divide of an image formation device, to a post-processing equipped with the stapler, and also to an image formation divide equipped with the post-processing device.

1A Stapler

10A Staple

11A Staple crown

12A(12Ab, 12Ac) Staple leg

13A Cut staple

2A Staple striking unit

20A Receiving portion

21A Feeding portion

22A Striking portion

3A Binding unit

30A Cut portion

31A Clincher portion

31B, 31C Clincher

32A Shaft

33A(33A_{L}, 33AR) Discharging path

34A_{L}, 34A_{R} Discharging port

4A Paper clamping portion

5A Drive unit

50A Motor

51A Cam

52A Link portion

6A Cut staple receiving unit

60A_{L}, 60A_{R} Collecting path

61A_{L}, 61A_{R} Collecting port

100A Staple cartridge

1. A stapler comprising:
a staple striking portion configured to strike a staple to penetrate sheets of paper; and
a clincher portion configured to bend staple legs of the staple penetrating the sheets of paper,
wherein the clincher portion comprises a pair of clinchers,
wherein the pair of clinchers are configured to perform a first operation and a second operation,
wherein in the first operation, the pair of the clinchers move along a surface direction of the sheets of paper to approach each other, and
wherein in the second operation, the pair of clinchers move to approach the sheets of paper after the first operation.

2. The stapler according to claim 1, wherein in the second operation, each of the pair of clinchers is pivoted about a point thereon, which abuts against the respective staple legs, as a pivot fulcrum.

3. The stapler according to claim 2, wherein in the second operation, a distance between the pivot fulcrums of the pair of clinchers is narrower than an inner width of a staple crown of the staple penetrating the sheets of paper.

4. The stapler according to claim 3, wherein in the second operation, the clincher comes in contact with a region of the staple leg of the staple, which penetrates the sheets of paper, ranging from the pivot fulcrum to a distal end the staple leg.

5. The stapler according to claim 1, further comprising:
a cutting portion configured to cut the staple legs of the staple penetrating the sheets of paper; and
a clincher link configured to operatively connect the cutting portion with the clincher portion.

6. The stapler according to claim 5,
wherein the cutting portion is configured to move to:
a first position where the cutting portion is advanced into an operation region of the pair of clinchers; and
a second position where the cutting portion is retracted from the operation region of the pair of clinchers; and
wherein the pair of clinchers are configured to perform the first operation in accordance with a movement of the cutting portion from the first position to the second position.

7. The stapler according to claim 6,
wherein the clincher link comprises a pair of clincher links,
wherein each of the clincher links is configured to movably support each of the clinchers, and
wherein in accordance with the movement of the cutting portion from the first position to the second position, the pair of the clincher links are pivoted to be closed to each other, and the pair of clinchers are configured to perform the first operation.

8. The stapler according to claim 7,
wherein each of the clincher links comprises:
a protrusion protruding from a location where the pair of the clincher links are opposed to each other, and
a recess adjacent to the protrusion,
wherein the cutting portion comprises the pair of the protrusions,
wherein each of the protrusions of the cutting portion is in contact with the protrusion or the recess of each of the clincher links, and
wherein in accordance with the movement of the cutting portion from the first position to the second position, the protrusions of the cutting portion move from a state, where the protrusions of the cutting portion are in contact with the protrusions of the clincher links, to a state, where the protrusions of the cutting portion are in contact with the recesses of the clincher links, and the pair of the clincher links are pivoted to be closed to each other.

9. The stapler according to claim 5,
wherein the cutting portion is configured to move to:
a first position where the cutting portion is advanced into an operation region of the pair of clinchers;
a second position where the cutting portion is retracted from the operation region of the pair of clinchers;
a third position where the cutting portion is retracted from the second position, and
wherein the pair of clinchers are configured to perform the second operation in accordance with a movement of the cutting portion from the second position to the third position.

10. The stapler according to claim 9 comprising a pressing portion which is configured to press the pair of the clinchers while the pair of clinchers are closed to each other,
wherein in accordance with the movement of the cutting portion from the second position to the third position, the pressing portion is configured to press the pair of the clincher links, and the pair of clinchers are configured to perform the second operation.

11. The stapler according to claim 10,
wherein the pressing portion comprises an inclined portion,
wherein the cutting portion comprises a shaft portion, and
wherein in accordance with the movement of the cutting portion from the second position to the third position, the shaft portion of the cutting portion is configured to push the inclined portion of the pressing portion, and the pressing portion is pivoted in a direction toward the pair of the clincher.
